(19) United States
(12) Patent Application Publication
(10) Pub. No.: US 2010/0054894 A1
(43) Pub. Date: Mar. 4, 2010

(54) Separate arm device for ensuring of a threaded coupling element

(76) Inventors: Maria Caballero Asensio, Getafe (ES); Gonzalo Ramirez Blanco, Getafe (ES)

Correspondence Address: WENDEROTH, LIND & PONACK, L.L.P., 1030 15th Street, N.W.,, Suite 400 East, Washington, DC, 20005-1503, US

(21) Appl. No.: 12/314,669

(22) Filed: Dec. 15, 2008

(30) Foreign Application Priority Data
Aug. 29, 2008 (ES) P200802518

(51) Int. Cl. F16B 21/10

(52) U.S. Cl. 411/524

(57) ABSTRACT

The device essentially consists of a substantially rigid piece that has a first portion (1), a second portion (2) and conventional means (3) for securing the piece onto a fastening surface (6).

The first portion (1) forms a space such that once the head (5) of the coupling element (4) is introduced inside the space, the rotation of the coupling element (4) around its own axis is prevented (anti-rotation function).

The second portion (2) is connected to the first portion (1) in a part of the second portion located opposite to the opening of the space through which the head (5) of the coupling element (4) is introduced. In such a way that once the piece is mounted on the head of the coupling element, the axial movement of the coupling element (4) is prevented (retention function).

### OBJECT OF THE INVENTION

As stated in the title of this specification, the following invention relates to providing a device for ensuring of a threaded coupling element.

Threaded coupling element is understood to be a coupling element of two surfaces for which the securing is carried out by means of a nut and auxiliary securing elements. A bolt, a screw or a pin can, therefore, be considered as coupling elements for the purposes of this patent.

The ensuring consists of providing adequate installation means for a threaded coupling so that, in the event that the securing of the threaded coupling element fails, the coupling maintain its functions intact, at least during an allowed period of time until the failure can be corrected.

According to the above definitions, the object of this patent is to provide an ensuring device for the threaded coupling element with the dual function that, once the device has been mounted in the threaded coupling, the device can, on its own: prevent rotation of the coupling element about its own axis (anti-rotation function) and prevent the coupling element from coming out of its mounting or moving axially (retention function), in the case in which the respective securing elements of the threaded coupling such as nuts or washers fortuitously fail, permitting the functioning of the threaded coupling in a fail-safe mode, in other words maintaining the coupling element in its correct position and with its functions intact in case of failure.

It is also an object of this patent to provide a device which, complying with above-stated functions, can be easy to manufacture and install.

### TECHNICAL FIELD OF THE INVENTION

The ensuring device of the present invention belongs to the group of devices for ensuring threaded coupling elements of the type known as “separate arm”.

This sort of ensuring devices is distinguished from another two sorts of device for ensuring threaded coupling elements and that are known as “structural” and “integrated arm” respectively.

In “separate arm” devices, which are the ones forming the object of the present invention, the ensuring of the coupling element is done entirely by the device itself. Nevertheless, “structural” and “integrated arm” devices require the assistance of some element not being part of the device. So, “integrated arm” devices require special designs for the coupling elements, normally in the head of the coupling element, being the head itself of the element the one in charge of carrying out the anti-rotation and retention functions. On the other hand, “Structural” devices are defined as those requiring special designs in elements different from the coupling element, such as machinings of fittings or of the surfaces of the coupling.

The present invention has application in any sector of industry where threaded coupling elements such as bolts, screws or pins are used and where it is crucial to prevent their rotation and axial movement in the direction of the axis of the coupling element. In this way, the device of the present invention preferably has application in elements installed in jointed couplings such as rotational fittings subject to structural loads which, in their functioning, can cause the loss of the nut or situations that cause the coupling element to start to rotate even though there exists a nut.

So, for example, the device has application in heavy industry, in the automobile industry, in the railway industry, in the aeronautical industry or similar.

In particular, the present invention was conceived for the aeronautical industry, more precisely for adding a safety element to the coupling of rotating fittings and actuators on the control surfaces of aircrafts.

### STATE OF THE ART PRIOR TO THE INVENTION

The following patent documents are currently known containing devices for ensuring threaded coupling elements of the “separate arm” type.

Document GB 129553 describes a metal sheet which prevents the rotation of a nut securing a bolt, said sheet being arranged between the nut and the surface to which the bolt is fitted, as a washer. Moreover, the sheet has a portion with an orifice through which the stem of the bolt passes and some lugs which, once the nut has been affixed, are folded in order to tighten the nut and prevent its rotation. It also has a second portion, which can be folded and in this way, by friction it remains secured to the surface to which the bolt is fitted, thus preventing the rotation of the nut. But document GB 129553 does not describe or suggest a device with dual functionality, anti-rotation and retention, and it would not be of any use for retaining a threaded coupling element in axial movement in the direction of the axis of the coupling element.

Document DE 9413342 U describes an anti-rotation sheet or plate which seeks to solve the problem of the reutilization of this type of plate, since in the past they used to be fixed to the surface to which the coupling element was fitted by means of adhesives. For this it defines not just a main orifice but also a second orifice through which a screw is passed in order to secure it to the surface of the coupling. In order to carry out this securing, the plate is folded in the shape of a “V”, leaving the main orifice in a plane different and not parallel to that of the smaller orifice used for securing the plate with the screw. This document also does not describe or suggest a device with dual functionality, anti-rotation and retention, and it would not be of any use for retaining a threaded coupling element in axial movement in the direction of the axis of the coupling element.

Document DE 3313540 describes a substantially circular plate with a lobe (25) having elastic properties, in such a way that it elastically secures the bolt via its nut or via its head, in order to prevent its rotation. Thus, the functioning principle of said device has a direct relation to the elastic properties of the device and it is not a rigid piece like that described in the present invention.

Document GB 2138912 A describes an annular element used for immobilizing nuts, having an orifive for the passage of the stem of the bolt, some lugs emerging towards the side of the nut and having at their free end some lips which, once the annular element has been tightened by axial impact with a special tool, they laterally tighten the nut and a lug towards the opposite side, in other words, the side of the piece to ensure which, when the annular element is tightened with the special tool, fixes said annular element to the piece to ensure in such a way that by friction it prevents the rotational movement of the nut. This document only describes an anti-rotation device and does not describe or suggest a device with dual functionality, anti-rotation and retention, and it too would not be of any use for retaining a threaded coupling element in axial movement in the direction of the axis of the coupling element.

Finally, documents FR 554054 and FR 470026 describe securing elements consisting of a ring which functions in a manner similar to a standard washer. Document FR 554054 clearly defines a ring being located between the head of the bolt and the surface to which it is fixed and having a projection for each side in such a way that it is also necessary to make a notch in the piece to ensure so that the projection facing towards the opposite side acts as a stop against the head of the bolt, so that between both projections and the notch they prevent the rotation of the bolt. And document FR 470026 describes a plate with four holes through which four screws are fitted to the nut and with a projecting lug (5) which is in the same plane as the rest of the plate and is folded in order to secure the nut laterally.

Nevertheless, these six documents existing in the prior art do not consider the cases in which the coupling element has to perform its functions in the case of breakage or loss of the nut, preventing rotation about its axis and axial movement about the axis, and therefore they do not solve all the possible functioning options.

In the aeronautical industry, in particular, it can occur that during the flight of an aircraft, owing to causes such as vibrations or abrupt changes of pressures or temperatures, the nut securing the bolt, screw or pin slackens, or becomes lost or breaks. In addition, bolts, screws or pins existing in certain zones of an aircraft have to perform their function in different positions, where it is feasible that different forces act on it, forces which tend to displace them axially. It is therefore crucial in this industry to successfully ensure certain coupling elements, bolts, screws or pins in rotation and in translation or axial movement in the direction of the coupling element.

Specifically in the aeronautical industry, the Rules of Aerial Navigation for control systems demand that the aircraft should be capable of continuing to fly safely and land even in the case of breakage or loss of the nut which secures a threaded coupling element. It is therefore necessary to ensure the structural integrity and the function of the control surfaces by means of a device which ensures the retention of the threaded coupling element in addition to preventing its rotation.

So, it was desirable to obtain a device which would solve the problems stated above, in other words, which would prevent the rotation of a bolt, screw or pin and which would prevent the axial movement in the direction of the threaded coupling element.

### DESCRIPTION OF THE INVENTION

The device for ensuring of a threaded coupling element described by the present invention is applied directly to the coupling element of the threaded coupling, in other words, to the bolt, pin or screw of the coupling. The same threaded coupling can consist of more than one coupling element, in which case being able to have an ensuring device like that described for each coupling element, the device that is described being intended for its application in a coupling element of the threaded coupling. In particular, the device of the present invention is applied to the head of the coupling element (bolt, screw or pin) and not, for example, to the nut of the coupling element.

The functioning principle of the ensuring of the threaded coupling element consists of preventing the rotation of the coupling element about its own axis (anti-rotation function) and preventing the coupling element from exiting from its mounting or moving axially (retention function), with the same device.

The ensuring device of the present invention is of the “separate arm” type as has been stated earlier, in other words, it essentially consists of a piece which by itself ensures the coupling element (bolt, screw or pin), regarding both the anti-rotation and the retention of the coupling element.

The anti-rotation function is basically achieved in the device by means of the provision of a first piece portion which, once provided on the head of the coupling element in its correct position, prevents the rotation movement of the head of the coupling element about its own axis, which is defined in the main direction of the stem of the coupling element.

A characteristic aspect of the invention is that it has specific application to coupling elements whose head has a prismatic shape and the transverse cross-section of the head is polygonal. In this way it becomes possible for the piece portion to prevent the rotation of the head of the coupling element once it has been arranged on the latter by the contact mechanism existing between the head of the coupling element and the piece portion when the coupling element tries to rotate about its own axis. This is achieved by rigidly interposing the side of the head of the coupling element with the first piece portion, with the former making contact with the latter when the coupling element tries to rotate about its own axis. So, the first piece portion comprises a space via which the head of the coupling element can pass with a certain play that is sufficiently large for providing a play to the passage of the head of the coupling element and sufficiently small so that, in the virtual rotation of the coupling element about its own axis, the side of the head of the coupling element makes tangential contact at some point with the edge of the space of the first piece portion when the virtual rotation of the coupling element is effected about its own axis.

Moreover, in order to achieve the retention function, the device incorporates a second piece portion which is connected to the piece portion described above or first piece portion. In order to achieve the retention function this second piece portion is provided in the device in the part opposite to the side via which the head of the coupling element is introduced into the space of the first piece portion. In this way, the same second piece portion prevents the passage of the head of the coupling element from coming into contact with the interior face of the second piece portion, seen from the interior of the space of the first piece portion where the head of the coupling element is housed. Between the interior surface of the second piece portion and the upper surface of the head of the coupling element there can exist a defined play with the aim of granting the coupling element a certain freedom of small movements required by the design of the coupling, such as vibrations.

Finally, the device incorporates conventional securing means for the piece to a fastening surface of the device close to the head of the coupling element such as the surface on which the head of the coupling element sits. These means can incorporate a piece portion of the device by means of which the first two piece portions are coupled to the fastening surface of the device, screws and securing nut, etc. Likewise, conventional securing means can be used such as adhesive couplings with their respective overlapping surface between the piece of the device and the fastening surface, etc.

### BRIEF DESCRIPTION OF THE FIGURES

The present invention shall be entirely understood on the basis of the brief description appearing below and the accompanying drawings that are presented, solely by way of example and thus not being restrictive within the invention, in which:

FIGS. 1 to 4 represent a first embodiment of the invention, in which:

FIG. 1 shows a perspective view of the first embodiment,

FIG. 2 shows another view in perspective of the first embodiment, in which the device appears affixed to the coupling element, as it is used,

FIG. 3 shows a view in transverse elevation of the device of the first embodiment, in which the device appears affixed to the coupling element, as it is used, and

FIG. 4 shows a view of the transverse cross-section A-A′ referenced to FIG. 3 of the device of the first embodiment, in which the device appears affixed to the coupling element, as it is used.

FIGS. 5 to 8 represent a second embodiment of the invention, in which:

FIG. 5 shows a perspective view of the second embodiment,

FIG. 6 shows another view in perspective of the second embodiment, in which the device appears affixed to the coupling element, as it is used,

FIG. 7 shows a view in transverse elevation of the device of the second embodiment, in which the device appears affixed to the coupling element, as it is used, and

FIG. 8 shows a view of the transverse cross-section A-A′ referenced to FIG. 7 of the device of the second embodiment, in which the device appears affixed to the coupling element, as it is used.

### REFERENCES

1: first portion
2: second portion
3: conventional means for securing of the device to the fastening surface
4: threaded coupling element
5: head of the threaded coupling element
6: fastening surface of the device
7 and 7′: anti-rotation lugs
8: retention plate
9: securing plate for the device of the first embodiment (third portion)
10: extension plate of the first embodiment (fourth portion)
11: anti-rotation plate (first portion of the second embodiment)
12: cavity in the anti-rotation plate
13: retention lugs
14: securing plate for the device of the second embodiment (third portion of the second embodiment)
15: extension plate of the second embodiment (fourth portion of the second embodiment).

### FORMS OF EMBODIMENT OF THE INVENTION

With the aim of arriving at a better understanding of the object and functioning of this patent, and without these being understood as restrictive solutions, given below is a description of two examples of the invention making reference to the numbering adopted in the figures.

Both embodiments that are described in this section can be manufactured by shaping starting from some metal plate. In these embodiments metal sheet has been selected on account of its technical advantages of lightness in weight and simplicity of manufacture, determining criteria in the particular field of application of aeronautics, the technical field for which the invention has preferably been conceived. Nevertheless, the invention would be equally applicable to any other kind of injectable or machinable material whose characteristics and/or cost make it suitable.

Moreover, the embodiments that are considered are applied to a coupling element whose head has a substantially prismatic shape and with a transverse cross-section that is in particular hexagonal.

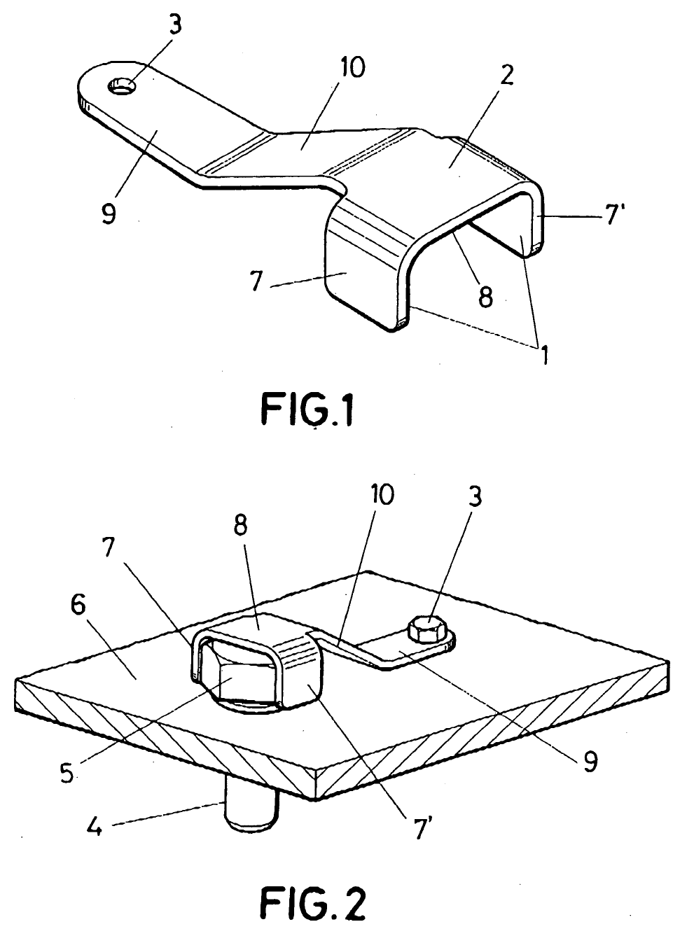

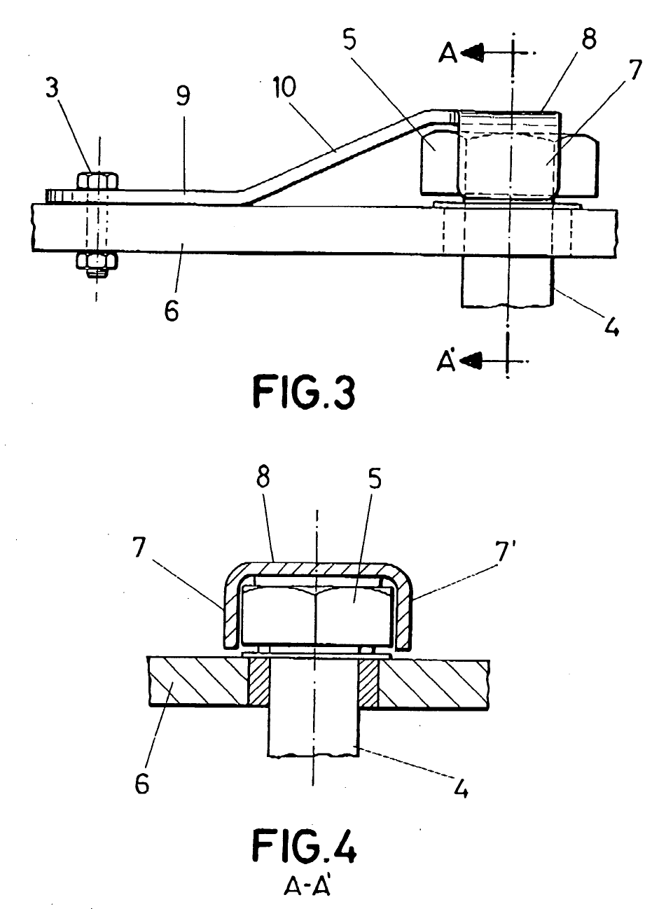

In a first embodiment of the invention, as can be seen in FIGS. 1 to 4, the piece of metal plate has a first portion 1 whose purpose is to perform the anti-rotation function, a second portion 2 whose purpose is to perform the retention function and means for securing 3 the plate to the fastening surface 6, which in the embodiment appears with the surface of the coupling on which sits the head of the coupling element.

The first portion of the first embodiment comprises of some lugs 7 and 7′ which are arranged facing each other at a distance such that permits the head 5 of the threaded coupling element 4 to fit in the space that results between the two lugs 7 and 7′. The two lugs 7 and 7′ are arranged substantially parallel to the side of the head 5 of the bolt which correspond to the facing sides of the hexagon of the transverse cross-section of the head of the coupling element, there existing a play between the contact surfaces such that the head 5 of the coupling element passes with a certain play between the two lugs 7 and 7′ and at the same time, in the case of virtual rotation of the coupling element about its own axis, contact takes place between the side faces and the lugs, in such a way that prevents the rotation.

The second portion 2 of the first embodiment is formed by a plate 8 substantially perpendicular to the lugs 7 and 7′, connecting the two lugs together. This plate is provided in the side opposite to the side through which the head 5 of the coupling element is introduced, such that when the plate comes into contact with the upper surface of the head 5 of the coupling element it prevents the axial displacement of the coupling element outside of its correct position.

The device is secured to the fastening surface 6, which in the embodiment is the surface on which sits the head of the coupling element. For this connection, the portions of plate mentioned above are coupled to the surface with means for securing 3 to the exterior surface 6. These securing means include a third portion 9 which serves as an overlapping surface in which a securing screw is provided with its corresponding nut and auxiliary securing elements. It also includes a fourth portion 10. This portion serves as a coupling between the second portion (2, 8) and the fourth portion 10. The fourth portion 10 is an extension plate that is arranged at an inclined angle and connected to the retention plate 8 by one edge and to the securing plate 9 by the opposite edge, so in a lateral view it can be seen how the end, connected to the retention plate 8, becomes displaced in terms of height with respect to the fastening surface, the height being that corresponding to the installation in the head of the coupling element, in other words in a different plane parallel with respect to the end connected to the securing plate 9, the fourth portion 10 being visualized as a ramp or slope between both ends.

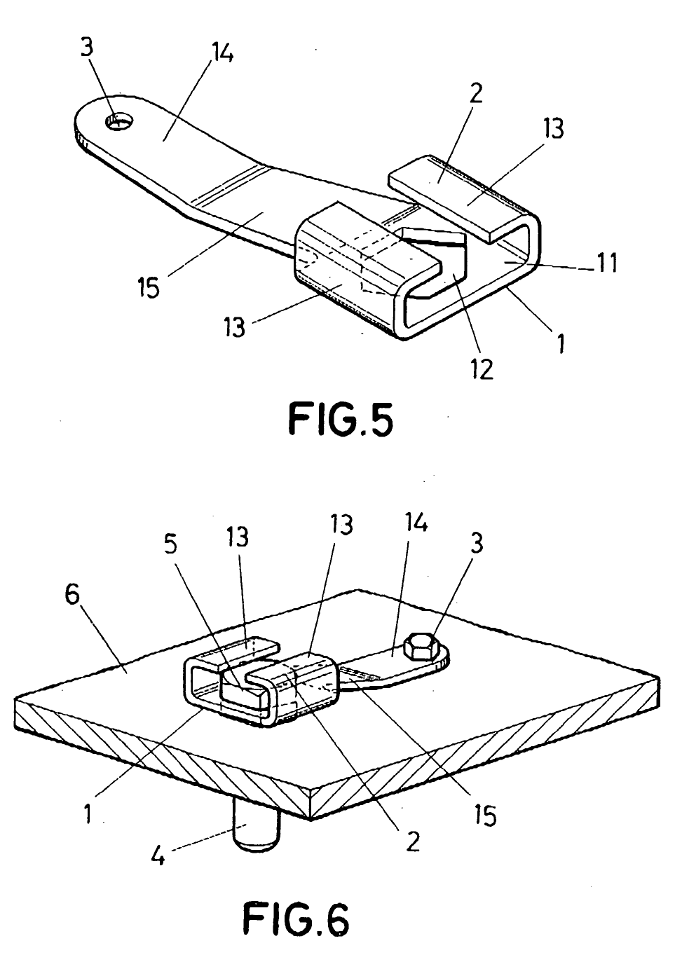

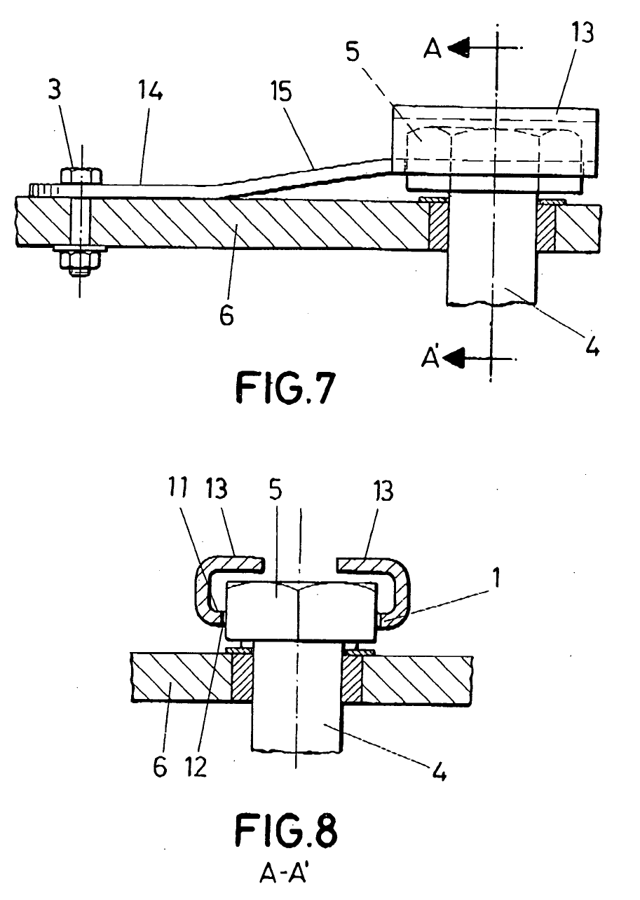

In a second embodiment of the invention, as can be seen in FIGS. 5 to 8, the metal piece has a first portion 1 whose purpose is to perform the anti-rotation function, a second portion 2 whose purpose is to perform the retention function and means for securing 3 the piece to the fastening surface 6.

The first portion of the first embodiment with the anti-rotation function consists of an anti-rotation plate 11 in which a cavity is made with the shape of the polygon of the head of the coupling element, with a play such that permits the play of that head in the cavity in the direction perpendicular to the surface of the plate. The second portion of the second embodiment with the retention function is connected to the first portion having some lugs 13 in an angular form with one part vertical to the anti-rotation plate 11 and another part horizontal in the opposite end to that in which the lug is connected to the plate 11. The horizontal part of the lugs 13 is located at a distance from the plate 8 such that the upper surface of the head of the bolt, once the device has been introduced into it on making contact with the horizontal part of the lugs 13, prevents the axial movement of the coupling element.

The distance existing between the horizontal part of the lugs 13 and the anti-rotation plate 11 is suitable so that both the anti-rotation function and the retention function can be effective, the anti-rotation plate being situated at an intermediate height of the head of the coupling element.

The portions mentioned above of the plate of the second embodiment are coupled to the fastening surface 6 with conventional means of securing 3 of the device, these means of securing including a third portion 14 which serves as an overlapping surface in which a securing screw is provided with its corresponding nut and auxiliary securing elements.

Analogously to the first embodiment between the portions 14 and 11, an extension plate 15 is provided with the corresponding inclination.

1. A separate arm device for ensuring of a threaded coupling element (4), such as a bolt, screw or pin, having the coupling element a head (5) of a substantially prismatic shape and polygonal transverse cross-section, particularly hexagonal, the device essentially consisting of a substantially rigid piece comprising:
A first portion (1) comprising a space whose interior edge has a shape such that allows the passage of the head of the coupling element with play through an opening of the space and in such a way that at least one zone of at least one side of the head of the coupling element tangentially contacts with the edge of the space of the first portion when the coupling element tends to rotate around its own axis once the head of the coupling element is introduced inside the space, in such a way that once the piece is mounted on the coupling element the rotation movement of the coupling element around its own axis is prevented due to contact being made between the side of the head of the coupling element and the edge of the space;
a second portion (2) connected to the first portion in a part of the second portion which is opposite to the opening of the space through which the head of the coupling element is introduced while positioning the coupling element, retaining the passage of the coupling element, in such a way that once the piece is mounted on the head of the coupling element the axial movement of the coupling element is retained in the direction of the axis of the coupling element; and
conventional means for securing (3) the piece to a fastening surface (6) of the device, substantially close to the head of the coupling element such as the surface of the coupling on which the head of the coupling element sits.

2. The device of claim 1, wherein it essentially consists of a plate comprising:
A first portion (1) comprising a at least two lugs (7, 7′) substantially flat and respectively arranged on two planes substantially perpendicular to a same horizontal plane and at a distance between them defined by the polygonal contour of the head of the coupling element, with which they make tangentially contact, preventing its rotation, with a play such that allows the play of the head (5) of the coupling element (4) via the space that remains between the lugs (7, 7′) in a direction substantially parallel to the surface of the lugs;
a second portion (2) or retention plate (8) connected to the lugs (7, 7′) of the first portion, substantially flat and perpendicular to the lugs opposing the positioning of the coupling element so as to retain the passage of the coupling element, in such a way that once the piece is mounted on the head (5) of the coupling element (4), the coupling element remains retained in its translation movement in the direction of the axis of the coupling element;
a third portion or securing plate (9) for securing the device to the fastening surface (6) including an orifice for a screw and complementary securing means (3), the surface of this third portion or securing plate being substantially parallel to the surface of the second portion (2); and
a fourth extension portion (10) between the second portion or retention plate (8) and the third portion or securing plate (9) which essentially consists of a section extended on a surface with a relative inclination with respect to the second portion and with respect to the third portion.

3. The device of claim 1, wherein it essentially consists of a metal plate comprising:
A first portion (1) or anti-rotation plate (11), substantially flat in which a cavity (12) having the shape of the polygon of the head (5) of the coupling element is made, with a play such that allows the play of said head via the cavity in a direction perpendicular to the surface of the plate;
a second portion (2), connected to the previous one, which includes at least one lug (13) which is provided folded with an angular shape and being extended in a direction towards the interior of the first portion up to a distance such that it retains the passage of the coupling element due to contact with the head (5) of said coupling element (4);
a third portion or securing plate (14) for securing the device to the fastening surface (6) includes an orifice for a screw and complementary securing means, the surface of this third portion being substantially parallel to the surface of the first portion; and
a fourth portion or extension plate between the first portion and the third portion which essentially consists of a section that extends on a surface with a relative inclination with respect to the first portion or anti-rotation plate (11) and with respect to the third portion or securing plate (14).

4. Installation method for the device described in claim 2, wherein once the threaded coupling element (4) has been installed with its nut and corresponding auxiliary elements, the method comprises the following steps:
positioning the device on the head (5) of the coupling element, in such a way that the lugs (7, 7′) remain in contact with the corresponding sides of the coupling head and with the head of the coupling element in the resulting space; and
securing the plate to the fastening surface of the device, by conventional securing means.

5. Installation method for the device described in claim 3, wherein once the threaded coupling element has been installed with its nut and corresponding auxiliary elements, the method comprises the following steps:
passing the head of the coupling element through the cavity of the first portion; and
securing the plate to the fastening surface, by conventional securing means.
